(19) United States
(12) Patent Application Publication
(10) Pub. No.: US 2006/0067175 A1
(43) Pub. Date: Mar. 30, 2006

(54) Optical disk drive for compensating wobble signal and method thereof

(75) Inventors: Jen-Yu Hsu, Taipei (TW); Hsiang-Yi Fu, Taipei (TW); Tun-Chieh Lee, Taipei (TW); Fu-Hsiang Chen, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/232,980

(22) Filed: Sep. 23, 2005

(30) Foreign Application Priority Data
Sep. 23, 2004 (TW) 93128923

(51) Int. Cl. G11B 7/00

(52) U.S. Cl. 369/44.13; 369/44.28; 369/47.36

(57) ABSTRACT

An optical disk drive for compensating wobble signal and the method thereof. The compensating method is used in a servo controller and an optical pick-up head. The optical pick-up head includes a laser diode, a photo detector and an objective lens. The servo controller includes an auto gain controller. Firstly, a beam is emitted by the laser diode emits and is focused on an optical disc to generate a reflective beam. Next, the photo detector receives the reflective beam to generate plural photo-detecting signals received by the auto gain controller to generate a first control signal and a second control signal. Then, the servo controller generates a third control signal according to the first and the second control signals. The objective lens is moved according to the third control signal. Lastly, the photo detector receives the reflective beam to generate plural calibrated photo-detecting signals whereby a wobble signal is generated.

This application claims the benefit of Taiwan application Serial No. 93128923, filed Sep. 23, 2004, the subject matter of which is incorporated herein by reference.

### BACKGROUND OF THE INVENTION

1. Field of the Invention

The invention relates in general to a method for compensating a wobble signal, and more particularly to an optical disc drive for compensating a wobble signal and the method thereof.

2. Description of the Related Art

The optical disc has a spiral track disposed thereon. The optical pick-up head emits a laser beam to the above track then receives the laser beam reflected from the track to read or write data. Generally speaking, the spiral track disposed on the optical disc has smooth edges. Currently, optical discs with special specifications such CD-R, DVD-R or DVD-RW have wave-like marks disposed on track edges. The marks are called wobble addressing marks, and the signal read and decoded from the marks are called wobble signal. The wobble signal defines the corresponding address of the data stored in the optical disc.

Therefore, the stability of wobble signal is crucial to the recording of the data. If the wobble signal is not stable or of poor quality, the corresponding address of the data cannot be correctly defined, resulting in recording failure of the optical disc easily.

### SUMMARY OF THE INVENTION

It is therefore the object of the invention to provide an optical disk drive for compensating wobble signal and the method thereof. A reflective beam of an optical disc is used to generate a number of photo-detecting signals whereby a first control signal and a second control signal are generated. A third control signal is generated according to the first control signal and the second control signal, and a number of calibrated photo-detecting signals are generated according to the third control signal. At last, a compensated wobble signal is generated according to the calibrated photo-detecting signals. Consequently, the quality of the signals is stabilized, the error rate in recording is reduced and the success rate in recording is increased.

According to an object of the invention, an optical disc drive for accessing an optical disc is provided. The optical disc drive includes a servo controller and an optical pick-up head. The servo controller includes an auto gain controller and is electrically coupled with the optical pick-up head. The optical pick-up head includes a laser diode, an objective lens and a photo detector. The laser diode is for emitting a beam. The objective lens is for focusing the beam on an optical disc to generate a reflective beam. The photo detector is for receiving the reflective beam and outputting a number of photo-detecting signals accordingly. After receiving the photo-detecting signals, the auto gain controller generates a first control signal and a second control signal to generate a third control signal accordingly. When the absolute value of the third control signal is larger than a fixed value, the servo controller moves the objective lens according to the third control signal for the photo detector to receive the reflective beam to generate the photo-detecting signals accordingly until the absolute value of the third control signal is not larger than the fixed value. Then, the reflective beam is received by the photo detector again to output a number of calibrated photo-detecting signals accordingly and a wobble signal is generated by the servo controller according to the calibrated photo-detecting signals.

According to another object of the invention, a method for compensating wobble signal used in a servo controller and an optical pick-up head accessing an optical disc is provided. The optical pick-up head includes a laser diode, a photo detector and an objective lens. The servo controller includes an auto gain controller. The compensating method includes the following steps. Firstly, a beam is emitted by the laser diode, and is focused on an optical disc via an objective lens to generate a reflective beam. Next, the reflective beam is received by the photo detector to generate a number of photo-detecting signals, which are received by the auto gain controller to generate a first control signal and a second control signal accordingly. Then, the servo controller generates a third control signal according to the first control signal and the second control signal. The objective lens is moved according to the third control signal when the absolute value of the third control signal is larger than a fixed value. The step of receiving the reflective beam by the photo detector to generate the photo-detecting signals is repeated until the absolute value of the third control signal is not larger than a fixed value. Then, the photo detector receives the reflective beam again to generate a number of calibrated photo-detecting signals. Lastly, a wobble signal is generated according to the calibrated electrical signals.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a structural diagram of an optical disc drive;

FIG. 2 is a diagram of a photo detector;

FIGS. 3A and 3B are diagrams when an absolute value of the third control signal is not equal to 0;

FIG. 4 is a flowchart of a compensating method according to a preferred embodiment of the invention.

### DETAILED DESCRIPTION OF THE INVENTION

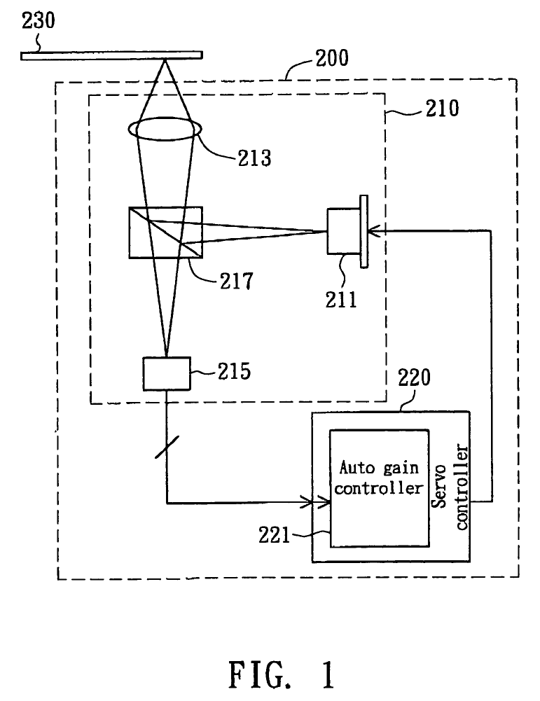

Referring to FIG. 1, a structural diagram of an optical disc drive is shown. An optical disc drive 200 includes a servo controller 220 and an optical pick-up head 210. The servo controller 220 includes an auto gain controller 221. The optical pick-up head 210 is electrically coupled with the servo controller 220. The optical pick-up head 210 includes a laser diode 211, an objective lens 213, and a photo detector 215 and a beam splitter 217. The laser diode 211 is for emitting a beam focused on the optical disc 230 via the beam splitter 217 and objective lens 213. The photo detector 215 is for receiving a reflective beam reflected by the optical disc 230 according to the beam intensity, then outputting a number of photo-detecting signals accordingly.

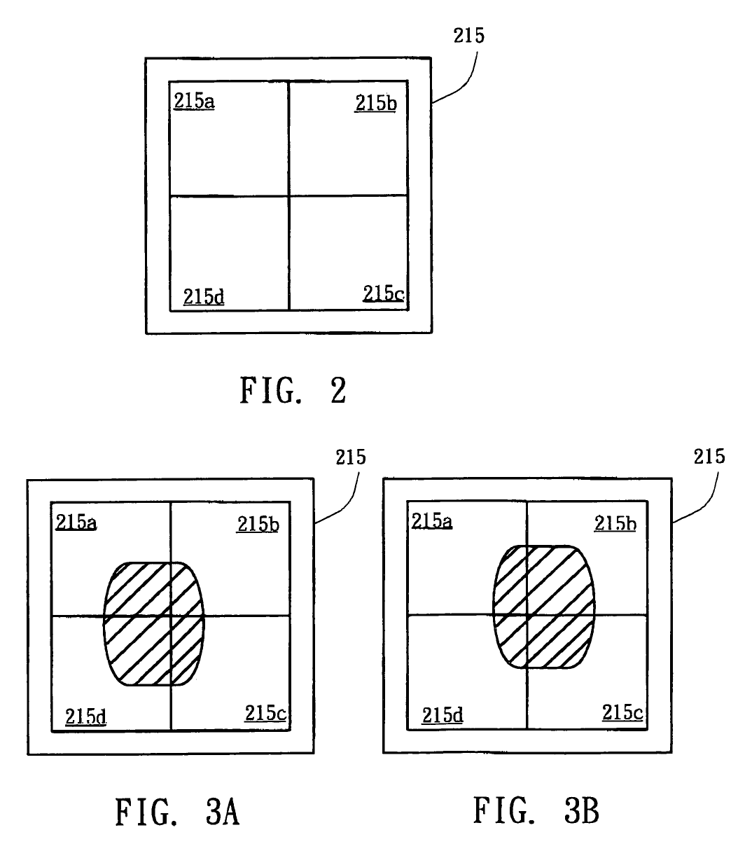

Referring to FIG. 2, a diagram of a photo detector is shown. The photo detector 215 has several photo-detecting elements 215a, 215b, 215c, 215d disposed thereon. The photo detector 215 generates four photo-detecting signals A, B, C and D according to the received light intensities of respective photo-detecting elements. The photo-detecting signals A, B, C and D can be processed by the servo controller 220 and then some signals such as a tracking error signal, a wobble signal and a focus error signal can be generated to facilitate accessing the data.

Taking the wobble signal as an example, after receiving the photo-detecting signals, the auto gain controller 221 provides the photo-detecting signals with respective gains (AGC1 and AGC2) to generate a first control signal and a second control signal accordingly. Then, the servo controller 220 generates a third control signal according to the first and second control signal, and decodes the third control signal to generate a wobble signal.

Refer to FIGS. 3A and 3B. If the photo detector 215 of the optical pick-up head is not precisely calibrated during manufacturing process, the light spots of the reflective beam would stably skew to one side of the photo-detector 215, one side of photo-detecting elements 215a and 215d as shown in FIG. 3A, or one side of photo-detecting elements 215b and 215c as shown in FIG. 3B. At this situation, the absolute value of the third control signal is larger than 0. If decode the third control signal to obtain a wobble signal, the error rate would be so high. That means the wobble signal cannot be effectively generated.

Therefore, when the absolute value of the third control signal is larger than a fixed value, the servo controller 220 have to moves the objective lens 213 according to the third control signal. When the objective lens is moving, the photo detector 215 is continuously receiving the reflective beam and generating four photo detecting signals. The object lens 213 has continuously to be moved until the absolute value of the third control signal is not larger than the fixed value. According to the present invention, when the absolute value of the third control signal is higher than the fixed value, the photo detector 215 receives the reflective beam to output a number of calibrated photo-detecting signals for the servo controller to generate the first control signal and the second control signal. The servo controller 220 decodes the third control signal according to the first and second signals to generate a wobble signal.

The optical disc 230 has a spiral track. The beam emitted by the laser diode 211 is focused on the track of the optical disc 230 via the objective lens 213 to generate a reflective beam. The above track has a number of wobble addressing marks disposed thereon. The photo-detecting signals outputted by the photo detector 215 include a first photo-detecting signal (A), a second photo-detecting signal (B), a third photo-detecting signal (C) and a fourth photo-detecting signal (D). The photo-detecting element 215a generates the first photo-detecting signal (A), the photo-detecting element 215b generate the second photo-detecting signal (B), the photo-detecting element 215c generates the third photo-detecting signal (C), and the photo-detecting element 215d generates the fourth photo-detecting signal (D). After receiving the photo-detecting signals, the auto gain controller 221 adjusts the gain (AGC1) of (A+D) to generate the first control signal, and adjusts the gain (AGC2) of (B+C) to generate the second control signal. The servo controller 220 receives the first control signal and the second control signal, and generates the third control signal [AGC1*(A+D)−AGC2*(B+C)]. If a higher quality of wobble signal is required, the fixed value can be set to 0, so that the absolute value of the third control signal is equal to 0 and that the quality of the wobble signal is further improved. When the absolute value of the third control signal is larger than a fixed value, the objective lens 213 is controlled to move transversely by the servo controller 220 according to the third control signal. Therefore, the absolute value of the third control signal is adjusted.

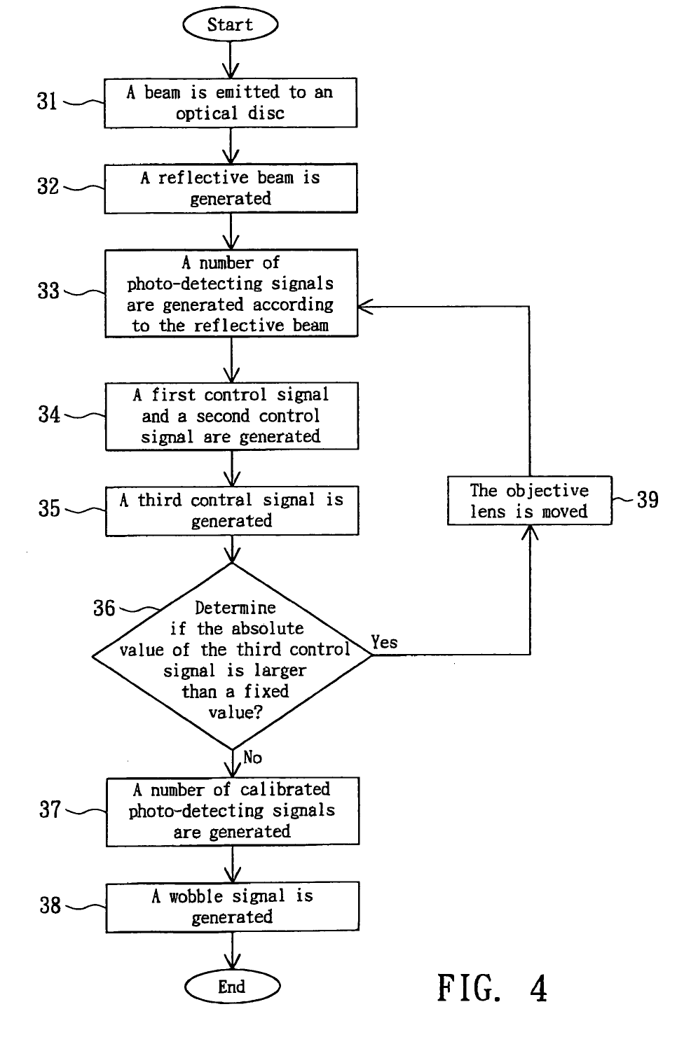

Referring to FIG. 4, a flowchart of a compensating method according to a preferred embodiment of the invention is shown. The compensating method is used in an auto gain controller and an optical pick-up head accessing an optical disc. The optical pick-up head includes a laser diode, beam splitter, a photo detector and an objective lens. Firstly, a beam is emitted by the laser diode to be focused on the optical disc via an objective lens as shown in step 31. Next, a reflective beam is generated by the optical disc as shown in step 32. Then, the reflective beam is received by the photo detector to generate a number of photo-detecting signals as shown in step 33. The auto gain controller of the servo controller provides gains to the photo-detecting signals so as to generate the first control signal and the second control signal accordingly as shown in step 34. A third control signal is generated by the servo controller according to the first control and the second control signal as shown in step 35. Then, whether the absolute value of the third control signal is larger than a fixed value is determined as shown in step 36. If the absolute value of the third control signal is larger than a fixed value, then the objective lens is moved transversely for instance to adjust the value of the third control signal as shown in step 39. The steps 33 to 36 are repeated until the absolute value of the third control signal is smaller than the fixed value. When the absolute value of the third control signal is smaller than the fixed value, the photo detector receives reflective beam to generate a number of calibrated photo-detecting signals as shown in step 37. Lastly, a wobble signal is generated according to the calibrated photo-detecting signals as shown in step 38.

In the step 34, the auto gain controller stabilizes and adjusts the gain (AGC1) of (A+D) to generate the first control signal, and stabilizes and adjusts the gain (AGC2) of (B+C) to generate the second control signal. In the step 35, the third control signal is set to [AGC1*(A+D)−AGC2*(B+C)]. If a higher quality of wobble signal is requested, the fixed value can be set to 0, so that the third control signal is equal to 0. That is, the value of [AGC1*(A+D)−AGC2*(B+C)] is equal to 0, so that the quality of the wobble signal is further improved.

The optical disc drive for compensating wobble signal and the method thereof disclosed in above embodiment of the invention compensate wobble signal according to the third control signal output from the servo controller, so that the corresponding address of the data when accessing an optical disc can be affirmed and that recording failure due to incorrect correspondence of data address can be reduced. Moreover, the compensating method is cost-benefit effective for not any extra devices or circuits are required.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for compensating wobble signals used in a servo controller and an optical pick-up head accessing an optical disc, the optical pick-up head comprises a laser diode, a photo detector and an objective lens, the servo controller comprises an auto gain controller, the compensating method comprises:
emitting a beam by the laser diode, wherein the beam is focused on the optical disc via the objective lens to generate a reflective beam;
receiving the reflective beam by the photo detector to generate a plurality of photo-detecting signals;
receiving the photo-detecting signals by the auto gain controller to generate a first control signal and a second control signal;
generating a third control signal by the servo controller according to the first control signal and the second control signal;
when the absolute value of the third control signal is larger than a fixed value, the objective lens is moved, and the above step of generating a plurality of photo-detecting signal to generate a third control signal is repeated until the absolute value of the third control signal is not larger than the fixed value, then the photo detector receives the reflective beam again to generate a plurality of calibrated photo-detecting signals; and
a wobble signal is generated according to the calibrated photo-detecting signals.

2. The method according to claim 1, wherein the optical disc has a spiral track, wherein the beam is focused on the track of the optical disc via the objective lens to generate a reflective beam, the track has a plurality of wobble addressing marks disposed thereon.

3. The method according to claim 1, wherein the photo-detecting signals comprise a first photo-detecting signal (A), a second photo-detecting signal (B), a third photo-detecting signal (C) and a fourth photo-detecting signal (D).

4. The method according to claim 3, in the step of generating a third control signal, the auto gain controller stabilizes and adjusts a first gain (AGC1) of (A+D) to generate the first control signal.

5. The method according to claim 4, in the step of generating a third control signal, the auto gain controller stabilizes and adjusts a second gain (AGC2) of (B+C) to generate the second control signal.

6. The method according to claim 5, wherein in the step of generating a third control signal, the third control signal is defined as [AGC1*(A+D)−AGC2*(B+C)].

7. The method according to claim 1, wherein when the absolute value of the third control signal is larger than a fixed value, the objective lens is moved transversely according to the third control signal.

8. An optical disc drive for accessing an optical disc, the optical disc drive comprises:
an optical pick-up head comprising:
a laser diode for emitting a beam;
an objective lens for focusing the beam to the optical disc; and
a photo detector for receiving a reflective beam generated by the optical disc according to the beam and outputting a plurality of photo-detecting signals accordingly; and
a servo controller electrically coupled with the optical pick-up head and comprising an auto gain controller, wherein the auto gain controller receive the photo-detecting signals to generate a first control signal and a second control signal;
wherein, the servo controller generates a third control signal according to the first control signal and the second control signal, and when the absolute value of the third control signal is larger than a fixed value, the servo controller moves the objective lens for the photo detector to receive the reflective beam to generate the photo-detecting signals until the absolute value of the third control signal is not larger than the fixed value, then the reflective beam is received by the photo detector to output a plurality of calibrated photo-detecting signals accordingly and a wobble signal is generated by the servo controller according to the calibrated photo-detecting signal.

9. The optical disc drive according to claim 8, wherein the optical disc has a spiral track, the beam is focused on the track of the optical disc via the objective lens to generate the reflective beam, the track has a plurality of wobble addressing marks.

10. The optical disc drive according to claim 8, wherein the photo-detecting signals comprise a first photo-detecting signal (A), a second photo-detecting signal (B), a third photo-detecting signal (C) and a fourth photo-detecting signal (D).

11. The optical disc drive according to claim 10, wherein the auto gain controller stabilizes and adjusts a first gain (AGC1) of (A+D) to generate the first control signal.

12. The optical disc drive according to claim 11, wherein the auto gain controller stabilizes and adjusts a second gain (AGC2) of (B+C) to generate the second control signal.

13. The optical disc drive according to claim 12, wherein the third control signal is defined as [AGC1*(A+D)−AGC2*(B+C)].

14. The optical disc drive according to claim 8, wherein the objective lens is moved transversely according to the third control signal.
